(19) United States
(12) Patent Application Publication
(10) Pub. No.: US 2013/0084419 A1
(43) Pub. Date: Apr. 4, 2013

(54) MOISTURE/VAPOR BARRIER AND METHOD OF MAKING AND USING SAME

(71) Applicants: Leslie Jay Taylor, Acworth, GA (US); Robert E. Robertson, III, Calhoun, GA (US); Joseph A. Tuttolomondo, JR., Calhoun, GA (US)

(72) Inventors: Leslie Jay Taylor, Acworth, GA (US); Robert E. Robertson, III, Calhoun, GA (US); Joseph A. Tuttolomondo, JR., Calhoun, GA (US)

(73) Assignee: TEXTILE RUBBER AND CHEMICAL COMPANY, INC., Dalton, GA (US)

(21) Appl. No.: 13/251,362

(22) Filed: Oct. 3, 2011

(51) Int. Cl. B32B 7/12; B32B 37/14; B32B 37/12; B32B 3/00

(52) U.S. Cl. 428/41.8; 428/190; 156/71

(57) ABSTRACT

The present invention comprises a water vapor barrier. The water vapor barrier comprises a water vapor impermeable substrate, the substrate comprising a sheet of polymeric material and the substrate having a width. The water vapor barrier also comprises a first fabric on one side of the substrate, the first fabric having a width less than the width of the substrate such that a portion of the substrate is exposed on both sides of the first fabric. A method of installing the water vapor barrier is also disclosed.

### FIELD OF THE INVENTION

The present invention generally relates to a moisture/vapor barrier. More particularly, this invention relates to a moisture/vapor barrier used as an underlayment for a floor covering material. The present invention also relates to a method of making the moisture/vapor barrier. The present invention also relates to a system for installing the moisture/vapor barrier on porous flooring, such as concrete. The present invention also relates to a system for seaming the moisture/vapor barrier.

### BACKGROUND OF THE INVENTION

Floor covering is a broad term used to describe any decorative material applied over a floor to provide a finished surface for walking upon. Floor coverings include, but are not limited to, carpet; carpet tile; area rugs; resilient flooring, such as linoleum or vinyl tile or sheeting; hardwood flooring; engineered wood flooring; ceramic tile; stone; terrazzo and the like. When a floor covering is applied over a porous subflooring, such as concrete, moisture or water vapor may migrate up through the concrete by capillary action and collected between the surface of the concrete and the floor covering. This moisture or water vapor has deleterious effects on adhesives used for holding the floor covering material to the concrete potentially causing debonding, deterioration of the floor covering material and microbial growth.

When a floor covering is to be installed over a concrete surface having potential problems with moisture or water vapor, it is known to install a moisture/water vapor barrier on the surface of the concrete before any floor covering material, or adhesive therefore, is applied. U.S. Pat. No. 6,673,432 and U.S. patent application Publication No. 2011/0173923 (both of which are incorporated herein by reference) discloses such water vapor barriers. These water vapor barriers are not entirely satisfactory because they are relatively expensive to manufacture and relatively difficult and expensive to install. Furthermore, these water vapor barriers of the prior art are not entirely successful at preventing moisture or water vapor from permeating therethrough, particularly at seams.

Therefore, it would be desirable to produce a moisture/vapor barrier system that is relatively inexpensive to manufacture and relatively easy to install. It would also be desirable to provide a moisture/vapor barrier system that is more effective at preventing moisture or water vapor from permeating therethrough.

### SUMMARY OF THE INVENTION

The present invention satisfies the foregoing needs by providing an improved water vapor barrier. The present invention is relatively easier to manufacture and install than prior art water vapor barriers. And, the present invention provides improved water vapor barrier performance.

In one disclosed embodiment, the present invention comprises a water vapor barrier. The water vapor barrier comprises a water vapor impermeable substrate, the substrate comprises a sheet of polymeric material and the substrate has a width. The water vapor barrier also comprises a first fabric on one side of the substrate, the first fabric having a width less than the width of the substrate such that a portion of the substrate is exposed on both sides of the first fabric. In a further disclosed embodiment, the water vapor barrier also comprises a first water vapor impermeable tape comprising a first water vapor impermeable backing, an adhesive disposed on one surface of the first backing, a first release sheet covering and releasably attached to one portion of the adhesive on the first backing and the other portion of the adhesive on the first backing attached to an exposed portion of the substrate adjacent the first fabric. In a further disclosed embodiment, the water vapor barrier also comprises a second fabric on the side of the substrate opposite the first fabric, the second fabric having a width less than the width of the substrate such that a portion of the substrate is exposed on both sides of the second fabric.

In another disclosed embodiment, the present invention comprises a method. The method comprises applying to a floor a first elongate sheet of a water vapor impermeable membrane comprising a first water vapor impermeable substrate, the first substrate comprising a sheet of polymeric material, the first substrate having a width; a first fabric on one side of the first substrate, the first fabric having a width less than the width of the first substrate such that a portion of the first substrate is exposed on both sides of the first fabric, the exposed portions of the first substrate forming opposed side edges of the first elongate sheet of the water vapor impermeable membrane. The first elongate sheet of a water vapor impermeable membrane also comprises a first water vapor impermeable tape comprising a first water vapor impermeable backing; an adhesive disposed on one surface of the first backing; a first release sheet covering and releasably attached to one portion of the adhesive on the first backing; and the other portion of the adhesive on the first backing attached to the exposed portion of the first substrate adjacent one of the edges of the first elongate sheet of a water vapor impermeable membrane. The method further comprises applying to a floor a second elongate sheet of a water vapor impermeable membrane comprising a second water vapor impermeable substrate, the second substrate comprising a sheet of polymeric material, the second substrate having a width; a first fabric on one side of the second substrate, the first fabric having a width less than the width of the second substrate such that a portion of the second substrate is exposed on both sides of the first fabric, the exposed portions of the second substrate forming opposed side edges of the second elongate sheet of a water vapor impermeable membrane. The method also comprises aligning the edges of the first and second elongate sheets of a water vapor impermeable membrane in abutting relationship; removing the first release sheet; and placing the exposed edge portion of the second substrate on the portion of the exposed adhesive of the first water vapor impermeable tape thereby adhering the second elongate sheet of water vapor impermeable membrane thereto.

In another disclosed embodiment, the present invention comprises a method. The method comprises applying to a floor a first elongate sheet of a water vapor impermeable membrane; applying to the floor a second elongate sheet of a water vapor impermeable membrane; aligning adjacent edges of the first and second elongate sheets of a water vapor impermeable membrane in abutting relationship; and adhering the abutting edge of the second elongate sheet of a water vapor impermeable membrane to a portion of a water vapor impermeable adhesive tape, a portion of which is adhered to the abutting edge of the first elongate sheet of water vapor impermeable membrane.

In another disclosed embodiment, the present invention comprises a method. The method comprises applying to a floor a first sheet of a water vapor impermeable membrane; applying to the floor a second sheet of a water vapor impermeable membrane; aligning adjacent edges of the first and second sheets of water vapor impermeable membrane in abutting relationship and such that the edge of the second sheet of water vapor impermeable membrane overlays a release sheet on an adhesive portion of a water vapor impermeable adhesive tape adhered to the abutting edge of the first sheet of water vapor impermeable membrane; removing the release sheet from the adhesive portion of the water vapor impermeable adhesive tape; and adhering the abutting edge of the second sheet of a water vapor impermeable membrane to the adhesive portion of the water vapor impermeable adhesive tape.

In another disclosed embodiment, the present invention comprises an article. The article comprises an elongate layer of a water vapor impermeable polymeric material; a layer of adhesive on one side of the layer of polymeric material; and a release sheet removably adhered to the adhesive layer, the release sheet being cut or perforated along a longitudinal center of the release sheet so that a portion of the release sheet can be removed from the adhesive layer while another portion of the release sheet remains.

In another disclosed embodiment, the present invention comprises a method. The method comprises applying to a floor a water vapor impermeable adhesive tape comprising a layer of a water vapor impermeable polymeric material; a layer of adhesive on one side of the layer of polymeric material; and a release sheet removably adhered to the adhesive layer, the release sheet being at least partially cut so that a portion of the release sheet can be removed from a portion of the adhesive layer while another portion of the release sheet remains. The method further comprises applying to the floor a first sheet of a water vapor impermeable membrane; removing a portion of the release sheet to expose a portion of the adhesive layer; adhering to the exposed portion of the adhesive layer an edge of the first sheet of water vapor impermeable membrane; applying to the floor a second sheet of a water vapor impermeable membrane; aligning an adjacent edge of the second sheet of water vapor impermeable membrane in butting relationship with the edge of the first sheet of water vapor impermeable membrane and overlaying the remaining portion of the release sheet; removing the remaining portion of the release sheet to expose the remaining portion of the adhesive layer; and adhering the abutting edge of the second sheet of water vapor impermeable membrane to the remaining portion of the adhesive layer.

Accordingly, it is an object of the present invention to provide an improved moisture/water vapor barrier.

Another object of the present invention is to provide an improved method of applying a moisture/water vapor barrier to a porous floor, especially concrete.

A further object of the present invention is to provide an improved moisture/water vapor impermeable tape for joining adjacent sheets of a moisture/water vapor impermeable membrane.

Another object of the present invention is to provide an improved method of joining adjacent sheets of a moisture/water vapor impermeable membrane.

Yet another object of the present invention is to provide a moisture/water vapor barrier that can be used over chemically abated concrete floors.

Another object of the present invention is to provide a moisture/water vapor barrier that can be used over concrete floors experiencing alkali silica reactions.

These and other objects, features and advantages of the present invention will become apparent after a review of the following detailed description of the disclosed embodiments and the appended drawing and claims.

### BRIEF DESCRIPTION OF THE DRAWINGS

FIG. 1 is a partial top plan view of a disclosed embodiment of a sheet of a water vapor membrane in accordance with the present invention.

FIG. 2 is a partial cross-sectional view taken along the line 2-2 of the sheet of water vapor membrane shown in FIG. 1.

FIG. 3 is schematic diagram of a method of manufacturing the water vapor membrane disclosed in FIGS. 1, 2 and 4.

FIG. 4 is a partial cutaway top plan view of the water vapor membrane shown in FIG. 1 shown with a water vapor impermeable adhesive tape attached to one edge of the water vapor membrane.

FIG. 5 is a partial cross-sectional view taken along the line 5-5 of the water vapor membrane and tape shown in FIG. 4.

FIG. 6 is a partial cutaway top plan view of the first water vapor membrane and tape shown in FIG. 4 shown with a second water vapor membrane in abutting relationship with the first water vapor membrane and the release sheet still on the adhesive tape.

FIG. 7 is a partial cutaway top plan view of the first water vapor membrane and tape shown in FIG. 4 shown with a second water vapor membrane in abutting relationship with the second water vapor membrane adhered to the adhesive tape.

FIG. 8 is a partial cross-sectional view taken along the line 8-8 of the first and second water vapor membranes and tape shown in FIG. 7.

FIG. 9 is a partial top plan view of a disclosed embodiment of a water vapor impermeable adhesive tape in accordance with the present invention.

FIG. 10 is a partial cross-sectional view taken along the line 10-10 of the adhesive tape shown in FIG. 9.

FIG. 11 is a partial top plan view of the adhesive tape shown in FIG. 9 above shown with two sheets of a water vapor membrane adhered thereto in end-to-end relationship.

FIG. 12 is a partial cross-sectional view taken along the line 12-12 of the adhesive tape with two sheets of a water vapor membrane adhered thereto shown in FIG. 11.

### DETAILED DESCRIPTION OF THE DISCLOSED EMBODIMENTS

As used herein, the term “water vapor impermeable” shall mean having a water vapor transmission rating below 0.3 as measured by ASTM E96 and having no increase in relative humidity above the water vapor membrane as measured by ASTM 2420-05.

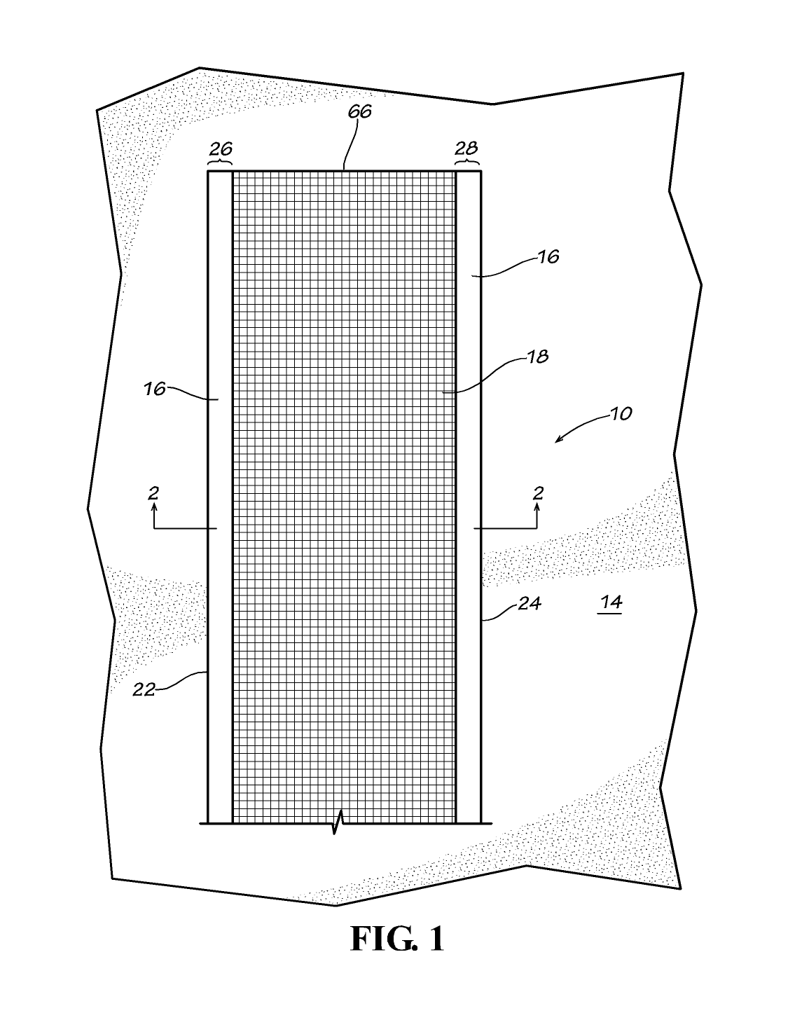

Referring now to the drawing in which like numbers indicate like elements throughout the several views, there is shown in FIG. 1 a disclosed embodiment of a water vapor impermeable membrane 10 in accordance with the present invention. The water vapor impermeable membrane 10 is shown laying flat on a horizontal concrete slab 12 having flat horizontal top surface 14. The water vapor impermeable membrane 10 comprises a first sheet of water vapor impermeable polymeric material 16. On either side (i.e., the top surface and the bottom surface) of the first sheet of water vapor impermeable polymeric material 16 are layers of fabric 18, 20 bonded to the first sheet of water vapor impermeable polymeric material. The width of the water vapor impermeable membrane 10 is not critical to the present invention. For commercial applications, the water vapor impermeable membrane 10 can be approximately 3 to approximately 12 feet wide; preferably approximately 6 feet wide; for residential applications, the water vapor impermeable membrane 10 can be approximately 2 to approximately 12 feet wide; preferably approximately 4 feet wide.

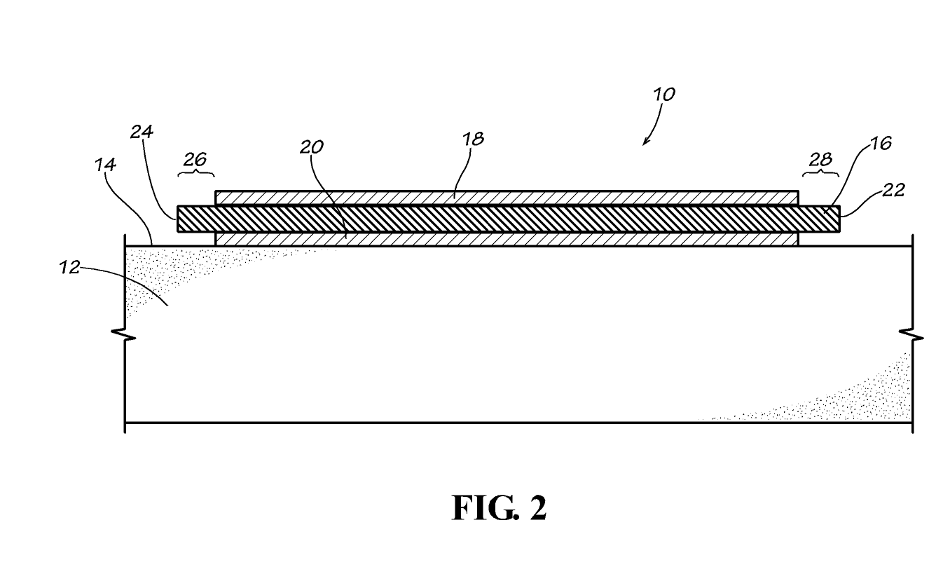

As can be clearly seen in FIGS. 1 and 2, the first sheet of water vapor impermeable polymeric material 16 is wider than the top and bottom layers of fabric 18, 20, respectively. Thus, flanking each side of the top and bottom layers of fabric 18, 20 are exposed; i.e., not covered by fabric, portions of the first sheet of water vapor impermeable polymeric material 16. Therefore, the top and bottom layers of fabric 18, 20 are disposed only in the middle of the first sheet of water vapor impermeable polymeric material 16 and do not extend out to the lateral edges 22, 24 of the first sheet of water vapor impermeable polymeric material 16. Accordingly, between the lateral edges 22, 24 and the top and bottom layers of fabric 18, 20 are two exposed edge portions 26, 28 of the first sheet of water vapor impermeable polymeric material 16. In accordance with the present invention, it is preferred that the edge portions 26, 28 of the first sheet of water vapor impermeable polymeric material 16 be approximately 1 to approximately 5 inches wide, especially approximately 3 inches wide. In accordance with the present invention, the water vapor impermeable polymeric membrane 10 can be attached to the underlying substrate, such as via adhesives or mechanical fasteners, or it can be free floating; i.e., not attached to the underlying substrate. The adhesive used to attach the water vapor impermeable polymeric membrane 10 to the underlying substrate is not critical to the present invention. A useful spray adhesive for attach the water vapor impermeable polymeric membrane 10 to the underlying substrate, such as the horizontal top surface 14 of the concrete slab 12, is commercially available under the designation Quantum Essentials from XL Brands, Resaca, Ga.; a useful mechanical fastener system is commercially available under the designation HK97 from Velcro USA Inc., Manchester, N.H.

The particular polymer from which the first sheet of water vapor impermeable polymeric material 16 is made is not critical to the present invention, except that it must be water vapor impermeable, lay flat on a flat surface; i.e., have no or virtually no memory, and be pliable and stable at temperatures ranging from about 0 to about 40° C. The first sheet of water vapor impermeable polymeric material 16 is preferably made from a thermoplastic including, but not limited to, ethylene methyl acrylate, polyethylene, polypropylene, acrylonitrile butadiene styrene, cellulose acetate, ethylene-vinyl acetate, polyacrylate, polyacrylonitrile, polyamide, polybutadiene, polybutylene, polybutylene terephthalate, polycaprolactone, polyethylene terephthalate, polycarbonate, polyester, polystyrene, polyurea, polyvinyl acetate, polyvinyl chloride, polyvinylidene chloride, styrene-acrylonitrile, ethyl butyl acrylate or mixtures thereof. Post consumer recycled turf can also be used for the first sheet of water vapor impermeable polymeric material 16. Recycled turf is typically made of polyethylene face fibers, polypropylene primary backing and a polyurethane or latex back coat. Pellets of recycled synthetic turf are commercially available under the designation ThermoTex 1311A from the ThermoTex Division of Textile Rubber and Chemical Company, Inc., Cartersville, GA. Mixtures of virgin polymer and recycled turf can also be used in any proportion. The first sheet of water vapor impermeable polymeric material 16 can be any thickness that is water vapor impermeable and is suitable for use as an underlayment for floor covering; preferably, approximately 0.002 to approximately 0.075 inches thick, especially approximately 0.035 inches thick.

The polymeric formulation from which the first sheet of water vapor impermeable polymeric material 16 is made may also optionally include typical polymer additives, including but not limited to, plasticizers; fillers; extenders; anti-microbials or biocides, such as mildewcides, bactericides or fungicides; deodorizers; antioxidants; antiseptic agents; antistatic agents; stabilizers; fire retardants; colorants and the like. Up to 50% by weight (based on the weight of the polymer) additives can be used in the present invention; preferably, up to 25% by weight. While fillers may be used in the formulation for the first sheet of water vapor impermeable polymeric material 16, the more filler that is added, the less water vapor impermeable the sheet becomes. In accordance with the present invention, it has been discovered that up to 50% by weight (based on the weight of the polymer) can be used successfully in the present invention; preferably, 0% to approximately 50% by weight; especially, approximately 25% by weight. Fillers useful in the present invention include, but are not limited to, post consumer recycled minerals, calcium carbonate, barium sulfate, clays, magnesium hydroxide, alumina trihydrate, talc, Portland cement, feldspar, glass cullet, fly ash, gypsum, and mixtures thereof.

The top and bottom layers of fabric 18, 20 can be the same or different; however, they are preferably the same. The top and bottom layers of fabric 18, 20 can be a woven or a nonwoven fabric. The top and bottom layers of fabric 18, 20 are preferably made from synthetic fibers, such as polyester, polyamide, polypropylene, cotton, wool, polylactic acid, polybutylene terephthalate, polyvinyl alcohol, polyvinyl chloride, polyethylene, polyurethane or acrylic. The top and bottom layers of fabric 18, 20 are preferably a nonwoven polyester point bond fabric, having a weight of approximately 50 grams per cubic meter. A nonwoven polyester point bond fabric having these properties is commercially available from Oxco, Inc. of Charlotte, N.C.

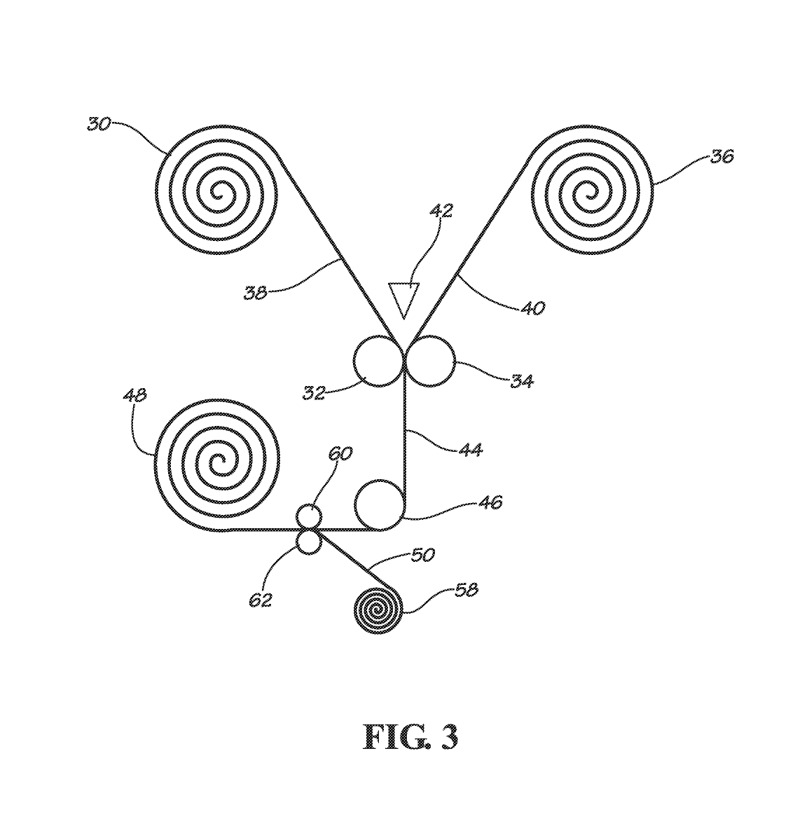

While the top and bottom layers of fabric 18, 20 can be attached to the first sheet of water vapor impermeable polymeric material 16 by any practical means known in the art, such as by an adhesive, it is preferred that the top and bottom layers of fabric be melt bonded to the first sheet of water vapor impermeable plastic. FIG. 3 shows a process for simultaneously forming the first sheet of water vapor impermeable polymeric material 16 and melt bonding the top and bottom layers of fabric 18, 20 to the opposite sides thereof. There is shown a first supply roll of fabric 30 disposed above and to the left of a pair of nip rolls 32, 34. A second supply roll of fabric 36 is disposed above and to the right of the nip rolls 32, 34. The fabric 38 from the supply roll 30 is fed between the two nip rolls 32, 34. The fabric 40 from the supply roll 36 is also fed between the two nip rolls 32, 34. The nip roll 32 is rotatably drive by an electric motor (not shown) which pulls the fabric 38, 40 through the gap between the two nip rollers 32, 34. An extruder 42 is disposed above the two nip rolls 32, 34. The extruder can be either a single screw extruder or a twin-screw extruder. Furthermore, a twin-screw extruder can have either co-rotating or counter rotating screws. A suitable extruder is commercially available under the designation Model G6000 from PTI Extruders of Aurora, Ill. Such extruders also include heated barrels for heating and/or melting the materials being processed therein. The barrel temperature can be adjusted to a desired temperature depending on the material be processed therein. For the present invention, the barrel temperature of the extruder should be hot enough to melt the thermoplastic polymers being processed therein, preferably approximately 325° F. to approximately 550° F., especially approximately 375° F. to approximately 450° F.

The polymer formulation; i.e., polymer(s) and any desired additives, for forming the sheet of water vapor impermeable polymeric material 16 is fed into the extruder 42 which both melts and mixes the plastic formulation and deposits the molten material onto the fabrics 38, 40 just as they pass between the nip rolls 32, 34. The nip rolls 32, 34 squeeze the molten plastic formulation between the two sheets of fabric 38, 40 as they pass between the nip rolls. This process forms the molten plastic formulation into a flat sheet of a desired thickness and simultaneously forces some of the molten plastic formulation into the opposed sheets of fabric 38, 40. The nip roll 34 is chilled with cold water so that as the molten plastic formulation passes between the nip rolls 32, 34 it is cooled, so that when the laminated composite structure 44 exits the nip rolls, the molten plastic formulation is solidified, or almost solidified. The solidification of the plastic formulation bonds the two sheets of fabric 38, 40 to the opposite sides of the sheet of water vapor impermeable polymeric material 16. The laminated composite structure 44 therefore comprises a first layer of fabric melt bonded to a layer of water vapor impermeable polymeric material and a second layer of fabric melt bonded to the opposite side of the layer of water vapor impermeable polymeric material. This laminated composite structure 44 corresponds to the laminated structure of the water vapor impermeable membrane 10 shown in FIGS. 1 and 2, wherein the fabric 38 corresponds to the top fabric 18 and the fabric 40 corresponds to the bottom fabric 20; i.e., the fabric adjacent to the surface 14 of the concrete slab 12. The laminated composite structure 44 travels from the nip rolls 32, 34 to the idle roll 46 and then to a take-up roll 48.

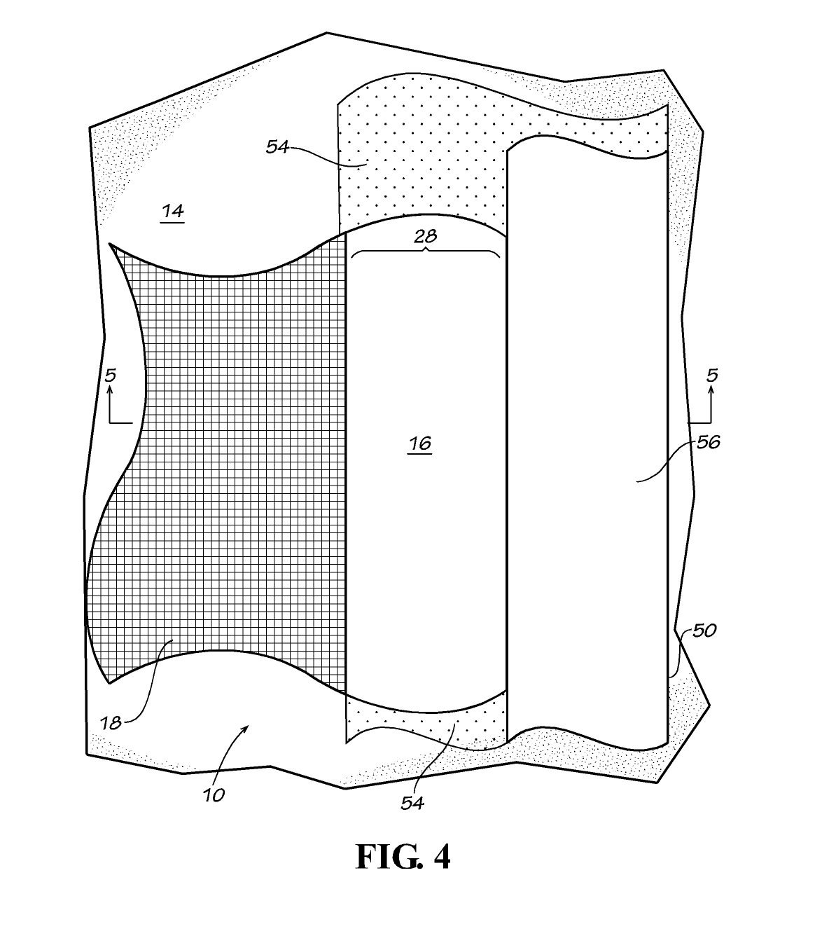

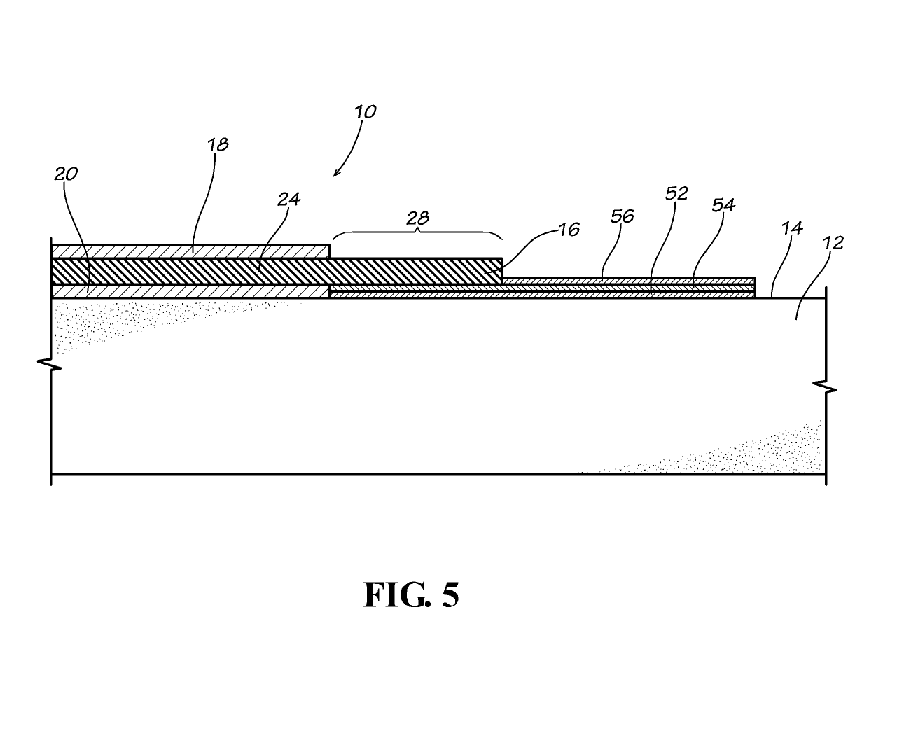

Optionally, before the laminated composite structure 44 is rolled up on the take-up roll 48, an adhesive tape 50 is applied to an edge portion, such as the edge portion 28, of the water vapor impermeable membrane 10. The adhesive tape preferably comprises a water vapor impermeable backing layer 52 and a water-proof or water-resistant adhesive layer 54 on one surface thereof. The backing layer 52 can be made from any water vapor impermeable material, including but not limited to, polyester, ethylene methyl acrylate, polyethylene, polypropylene, acrylonitrile butadiene styrene, cellulose acetate, ethylene-vinyl acetate, polyacrylate, polyacrylonitrile, polyamide, polybutadiene, polybutylene, polybutylene terephthalate, polycaprolactone, polyethylene terephthalate, polycarbonate, polystyrene, polyurea, polyvinyl acetate, polyvinyl chloride, polyvinylidene chloride, styrene-acrylonitrile, ethyl butyl acrylate or mixtures thereof, and the like. The adhesive can be any suitable adhesive, such as pressure sensitive adhesives, contact adhesives, UV-curable adhesives, RF-curable adhesives, thermosetting adhesives and the like. In the presently disclosed embodiment, a water-vapor impermeable adhesive tape useful in the present invention having a low permeance high-density polyethylene film backing and a pressure-sensitive adhesive is commercially available under the designation Stego Tape from Stego Industries, LLC. San Clemente, Calif. Covering one-half of the adhesive layer 54 is a release sheet 56 (FIGS. 4 and 5). The release sheet 56 can be made from any suitable material that will not adhere to the adhesive layer 54 too aggressively, so that it can be relatively easily removed therefrom without damaging the adhesive layer. Many types of materials are known in the art that are useful as a release sheet. However, in the present disclosed embodiment, the release sheet is preferably made from waxed paper so that it can be recycled. The adhesive tape 50 is fed from a supply roll 58 to a pair of nip rolls 60, 62 disposed between the idle roll 46 and the take-up roll 48. The exposed portion of the adhesive layer 54 of the adhesive tape 50 is applied to the under side of the edge portion 28 of the water vapor impermeable membrane 16 as they both pass between the rolls 60, 62 (FIG. 3). When the rolls 60, 62 press the exposed portion of the adhesive layer 54 of the adhesive tape 50 together with the under side of the edge portion 28 of the sheet of water vapor impermeable polymeric material 16, the adhesive tape 50 becomes attached to the edge portion of the water vapor impermeable membrane, as shown in FIGS. 4 and 5. The adhesive tape 50 is more than 2 inches wide, preferably approximately 3 to approximately 6 inches wide, especially approximately 4 inches wide.

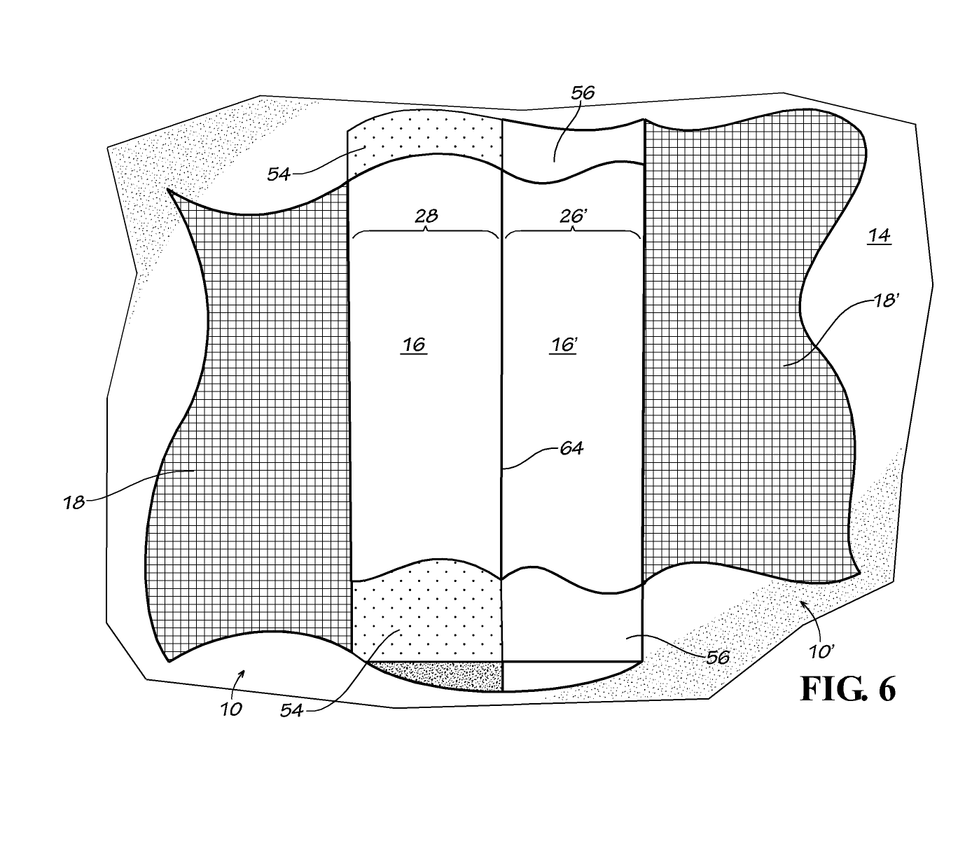

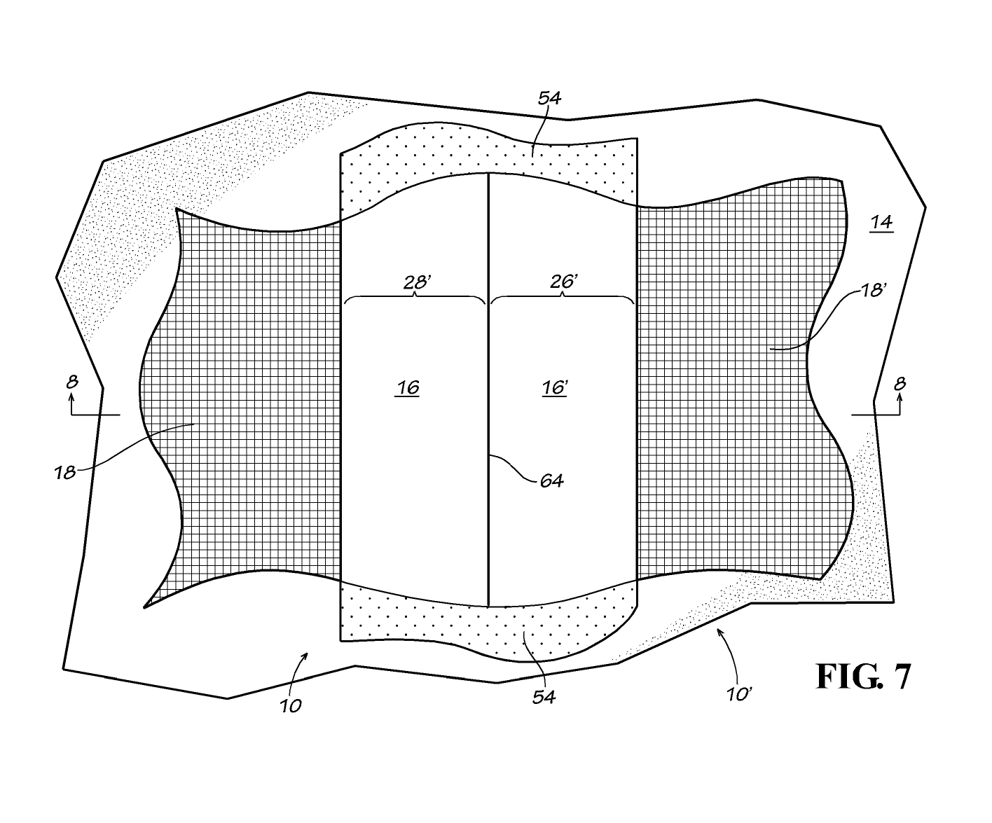

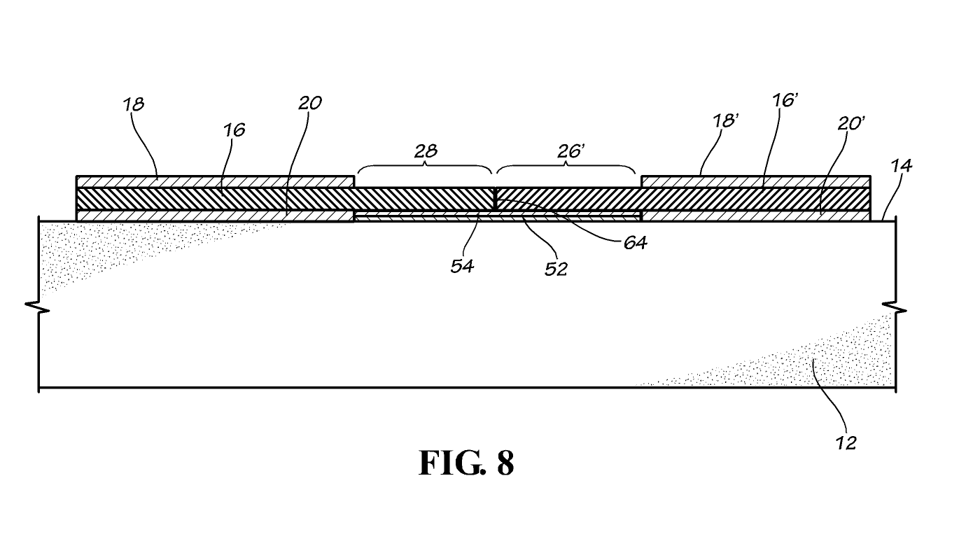

Use of the water vapor impermeable membrane 10 will now be considered. The water vapor impermeable membrane 10 is preferably in a roll, such as the roll 48 shown in FIG. 3. The water vapor impermeable membrane 10 is used by laying the membrane on a flat, clean surface of a porous floor, such as the surface 14 of the concrete slab 12, as shown in FIGS. 1, 2 and 4. This can be done by unrolling from the roll 48 a desired first length of the water vapor impermeable membrane 10 onto the concrete floor surface 14. The first water vapor impermeable membrane 10 is then cut from the roll 48 and the first water vapor impermeable membrane is positioned on the floor as desired. Then, a second length of the water vapor impermeable membrane 10′, which is identical in construction to the first water vapor impermeable membrane 10, is placed on the surface 14 of the concrete slab 12. This can be done by unrolling from the same roll 48 a desired second length of the water vapor impermeable membrane onto the concrete floor surface 14. The second water vapor impermeable membrane 10′ is then cut from the roll 48 and the second water vapor impermeable membrane is positioned on the floor adjacent the first water vapor impermeable membrane 10. The second water vapor impermeable membrane 10′ is then position in abutting relationship with the first water vapor impermeable membrane 10 (FIG. 6) such that the edge portion 26′ of the second water vapor impermeable membrane overlays the release sheet 56 and such that the edge portion 28 of the first water vapor impermeable membrane and the edge portion 26′ of the second water vapor impermeable membrane form a tight butt joint 64. The edge portion 26′ of the second water vapor impermeable membrane 10′ is then lifted temporarily from the adhesive tape 50 and the release sheet 56 is removed from the adhesive tape. After the release sheet 56 is removed, the edge portion 26′ of the second water vapor impermeable membrane 10′ is pushed down onto the adhesive layer 54 of the adhesive tape 50 (FIGS. 7 and 8). The edge portions 28, 26′ are then rolled with a weight to insure adhesion of the adhesive layer 54 to the edge portions of the first and second water vapor impermeable membranes 10, 10′. This procedure is repeated with additional sections of water vapor impermeable membrane until the floor surface is covered with the water vapor impermeable membrane.

It has been discovered as a part of the present invention that moisture or water vapor may penetrate horizontally up to 1 inch through the adhesive bond, such as the adhesive bond used to attach the adhesive tape 50 to the first and second water vapor impermeable membranes 10, 10′, due to water or water vapor seeping under the lateral edges of the adhesive tape. As stated above, the adhesive tape 50 is preferably 4 inches wide. Thus, there are approximately 2 inches of overlap between the adhesive tape 50 and each of the edge portions 28, 26′ of the first and second water vapor impermeable membranes 10, 10′. Therefore, if any moisture or water vapor penetrates under the lateral edges of the adhesive layer 54 of the adhesive tape 50, it will not penetrate to the joint 64 between the first and second water vapor impermeable membranes 10, 10′ because that joint is more than one inch way from the lateral edges of the adhesive tape. Thus, the present invention prevents, or substantially reduces, the penetration of moisture or water vapor between the adhesive tape 50 and the first and second water vapor impermeable membranes 10, 10′. Also, since the tape 50 is placed on the bottom of the first and second water vapor impermeable membranes 10, 10′, instead of on the top, as done in the prior art, the tape further reduces the possibility of moisture or water vapor penetrating through the joint 64 between the first and second water vapor impermeable membranes 10, 10′.

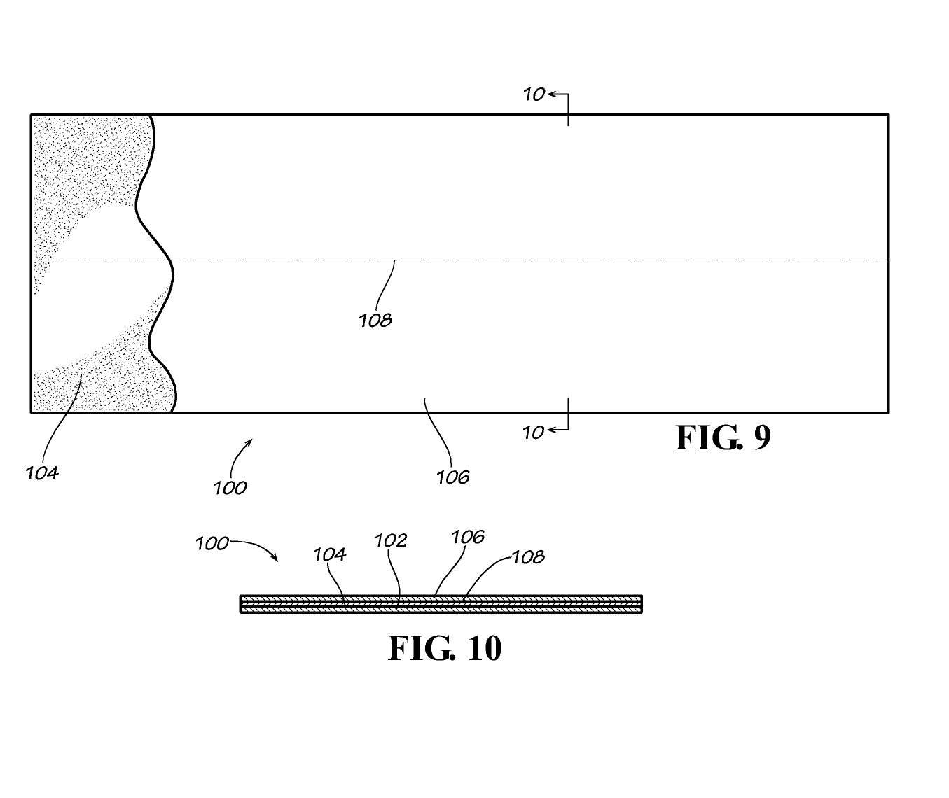

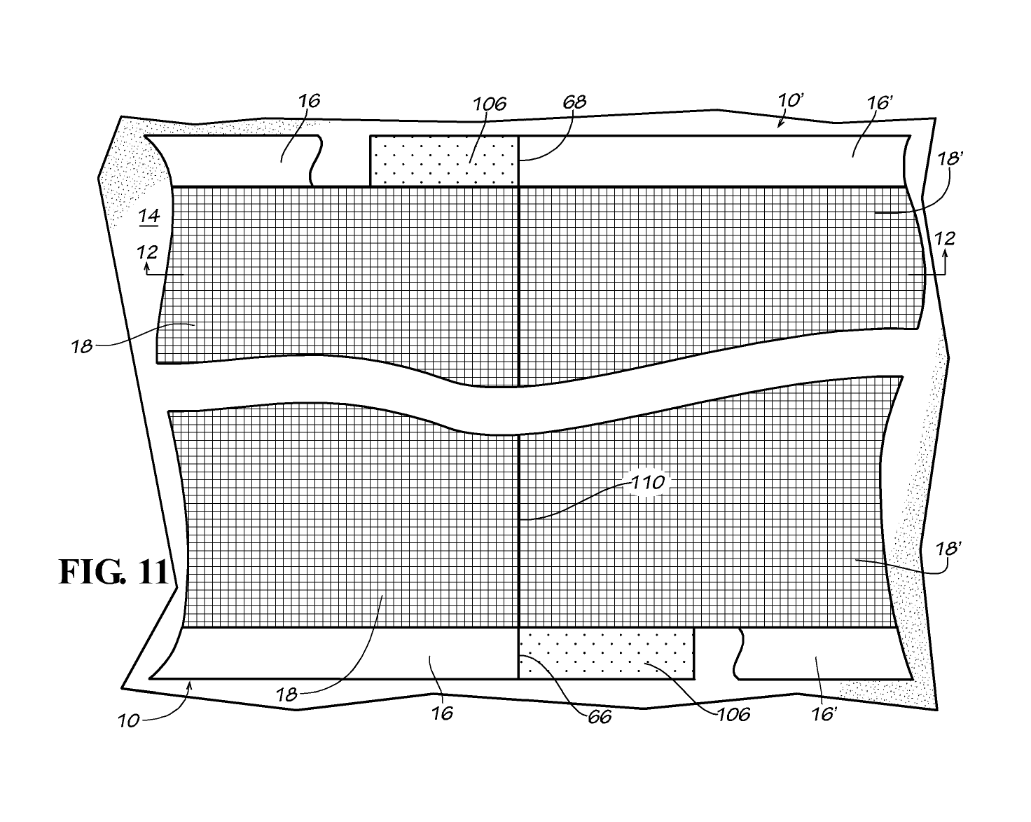

The foregoing describes the joining of adjacent sheets of the water vapor impermeable membrane in side-by-side relationship. However, it is often necessary to join multiple sheets of the water vapor impermeable membrane in end-to-end relationship in order to obtain a sheet of a longer desired length. The leading or trailing edge of a sheet of the water vapor impermeable membrane, such as the leading edge 66 of the first water vapor impermeable membrane 10 (FIGS. 1 and 11) and the trailing edge 68 of the second water vapor impermeable membrane 10′ (FIG. 11), are found at the beginning and end of a roll of the water vapor impermeable membrane and are also formed when the water vapor impermeable membrane is cut from the roll. The leading edge of a sheet of the water vapor impermeable membrane can be joined with the trailing edge of another sheet of the water vapor impermeable membrane in accordance with the present invention. For this joinder, a different type of adhesive tape is required. As shown in FIGS. 9 and 10, there is an adhesive tape 100. The adhesive tape 100 preferably comprises a water vapor impermeable backing layer 102 and a water-proof adhesive layer 104 on one surface thereof. The water vapor impermeable backing layer 102 can be made from any water vapor impermeable material, including but not limited to, polyester, ethylene methyl acrylate, polyethylene, polypropylene, acrylonitrile butadiene styrene, cellulose acetate, ethylene-vinyl acetate, polyacrylate, polyacrylonitrile, polyamide, polybutadiene, polybutylene, polybutylene terephthalate, polycaprolactone, polyethylene terephthalate, polycarbonate, polystyrene, polyurea, polyvinyl acetate, polyvinyl chloride, polyvinylidene chloride, styrene-acrylonitrile, ethyl butyl acrylate or mixtures thereof, and the like. The adhesive can be any suitable adhesive, such as pressure sensitive adhesives, contact adhesives, UV-curable adhesives, RF-curable adhesives, thermosetting adhesives and the like. In the presently disclosed embodiment, the adhesive is a conventional water-proof or water-resistant acrylic-based contact adhesive, such as a pressure sensitive adhesive commercially available under the designation Quantum Essentials from XL Brands, Resaca, Ga. Covering all of the adhesive layer 104 is a release sheet 106. The release sheet 106 can be made from any suitable material that will not adhere to the adhesive layer 106 to aggressively, so that it can be relatively easily removed therefrom without damaging the adhesive layer. Many types of materials are known in the art that are useful as a release sheet. However, in the present disclosed embodiment, the release sheet is preferably made from waxed paper so that it can be recycled. The release sheet 106 covers the entire adhesive layer 104. The release sheet 106 is cut or perforated along the longitudinal centerline 108 of the release sheet. The cut or perforation penetrates through the release sheet 106, but does not penetrate through the adhesive layer 104 or the backing layer 102, so that the release sheet can be removed one-half at a time, as desired. The adhesive tape 100 is more than 2 inches wide, preferably approximately 3 to approximately 6 inches wide, especially approximately 4 inches wide.

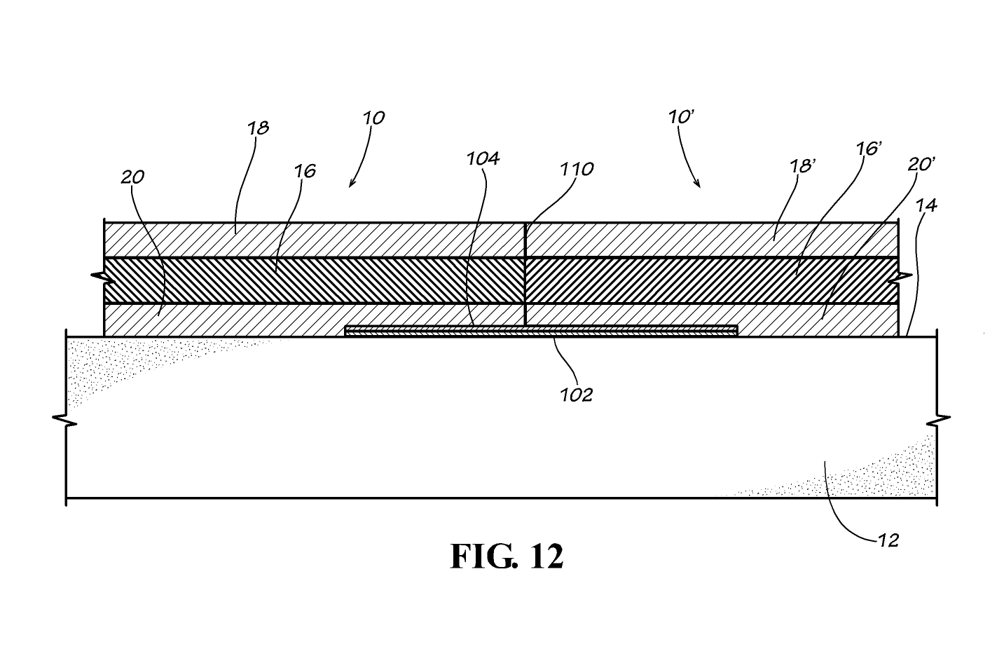

The leading and trailing edge of two sheets of the water vapor impermeable membrane are joined together, as shown in FIG. 11. A first water vapor impermeable membrane 10 is laid on a flat, clean surface of a porous floor, such as the horizontal; surface 14 of the concrete slab 12, as shown in FIGS. 11 and 12. This can be done by unrolling from the roll 48 a desired first length of the water vapor impermeable membrane 10 onto the concrete floor surface 14. The first water vapor impermeable membrane 10 is then cut from the roll 48 and the first water vapor impermeable membrane is positioned on the floor as desired. A strip of the adhesive tape 100 equal to the width of the first water vapor impermeable membrane 10 is cut from a roll thereof and laid on the floor adjacent the first water vapor impermeable membrane 10. The leading edge 66 of the first water vapor impermeable membrane 10 is laid on top of the release sheet 106 of the adhesive tape 100. The leading edge 66 is aligned with the cut or perforated centerline 108 of the adhesive tape 100. The leading edge 66 the first water vapor impermeable membrane 10 is then lifted temporarily and the portion of the release sheet 106 under the leading edge is removed from the adhesive tape 100 leaving the other portion of the release sheet in place on the adhesive tape. After the first portion of the release sheet 106 is removed, the leading edge 66 of the first water vapor impermeable membrane 10 is pushed down onto the exposed portion of the adhesive layer 104 of the adhesive tape 100 (FIGS. 11 and 12). Then, a second length of the water vapor impermeable membrane 10′, which is identical in construction to the first water vapor impermeable membrane 10, is placed on the surface 14 of the concrete slab 12. This can be done by unrolling from the same roll 48 a desired second length of the water vapor impermeable membrane onto the concrete floor surface 14. The second water vapor impermeable membrane 10′ is then cut from the roll 48 and the second water vapor impermeable membrane is positioned on the floor adjacent the first water vapor impermeable membrane 10. The second water vapor impermeable membrane 10′ is then position end-to-end with the first water vapor impermeable membrane 10′; i.e., so that the trailing edge 68 of the second water vapor impermeable membrane 10′ is aligned with and the leading edge 66 of the first water vapor impermeable membrane 10 so as to form a butt joint 110 therebetween, as shown in FIGS. 11 and 12. The trailing edge 68 of the second water vapor impermeable membrane 10′ is then lifted temporarily and the portion of the release sheet 106 under the trailing edge is removed from the adhesive tape 100 exposing the remaining portion of the adhesive layer 104. After the release sheet 106 is removed, the trailing edge 68 of the second water vapor impermeable membrane 10′ is pushed down onto the exposed portion of the adhesive layer 104 of the adhesive tape 100 (FIGS. 11 and 12). The leading and trailing edges 66, 68 are then rolled with a weight to insure adhesion of the adhesive layer 104 to the leading and trailing edge portions of the first and second water vapor impermeable membranes 10, 10′. This procedure is repeated with additional sections of water vapor impermeable membrane, as needed.

The following examples are illustrative of selected embodiments of the present invention and are not intended to limit the scope of the invention.

### Example 1

The following test was performed on four test samples of the water vapor impermeable membrane as described above. For these tests, the fabric layers were omitted from the water vapor impermeable membrane. The four water vapor impermeable membranes were made from different thermoplastic polymers and different combinations of polymers. The purpose of the test was to determine whether those test samples were water vapor impermeable. The tests were performed in accordance with ASTM E96 and ASTM F2420 for the determination of water vapor transmission and permeance.

### Apparatus

Test Dish

The test dish was made from a non-corroding material, impermeable to water or water vapor. The mouth of the dish was 3.875 in². The desiccant or water area the same as the mouth area.

Test Chamber

The cabinet where the assembled test dishes were placed had controlled temperature and relative humidity. The relative humidity was maintained at 50%. Both temperature and relative humidity were measured frequently. Air was continuously circulated throughout the chamber, with a velocity sufficient to maintain uniform conditions at all test locations. The air velocity over the specimen was 0.1 ft/s. Racks were provided on which to place the test dishes within the test chamber.

Balance and Weights

The balance was sensitive to a change smaller than 1% of the weight change during the period when a steady state was considered to exist. The weights used were accurate to 1% of the weight change during the stead-state period.

Thickness-Measuring Gage

The nominal thickness of the specimen was determined using a thickness-measuring gage with an accuracy of 0.00005 in.

### Procedure for Desiccant Method

The test dish was filled with desiccant within ¼ in. (6 mm) of the specimen. The specimen was attached to the dish and placed in the controlled chamber, specimen up, weighing it at once. The dish was weighed every 24 hours.

### Calculation and Analysis of Results

Numerical Analysis

The water vapor transmission and permeance were calculated as follows:

Water Vapor Transmission:

WVT=G/tA=G/t/A

Where:

In inch-pound units:

G=weight change, grains (from the straight line),

t=time during which G occurred, h,

G/t=slope of the straight line, grains/h,

A=test area (cup mouth area), ft², and

Permeance:

WVT/Dp=WVT/S(R₁−R₂)

Where:

In inch-pound units:

Dp=vapor pressure difference, inches Hg,

S=saturation vapor pressure at test temperature, inches Hg,

R₁=relative humidity at the source expressed as a fraction (the test chamber for desiccant method; in the dish or water method), and

R₂=relative humidity at the vapor sink expressed as a fraction.

### Results:

A) 100% Recycled Synthetic Turf having a polyethylene face fiber, polypropylene primary and polyurethane back coat.
Water Vapor Transmission=0.0114 grains/hr/ft²
Permeance=0.046

B) 100% ethyl methyl acrylate (Westlake SP2207).
Water Vapor Transmission=0.0172 grains/hr/ft²
Permeance=0.047

C) 75% ethyl methyl acrylate (Westlake SP2207)+25% Recycled

Synthetic Turf.
Water Vapor Transmission=0.0172 grains/hr/ft²
Perm=0.047

D) 75% ethyl methyl acrylate (Westlake SP2207)+25% recycled mineral filler (Cimbar RMF75).
Water Vapor Transmission=0.0172 grains/hr/ft²
Perm=0.048

A water vapor transmission of 0.3 grains/hr/ft² is considered to be water vapor impermeable. Similarly, a permeance of less than 0.3 is considered to be water vapor impermeable. Therefore, the foregoing tests demonstrate that all four samples were water vapor impermeable.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. An article comprising:
a water vapor impermeable substrate, the substrate comprising a sheet of polymeric material, the substrate having a width; and
a first fabric on one side of the substrate, the first fabric having a width less than the width of the substrate such that a portion of the substrate is exposed on both sides of the first fabric.

2. The article of claim 1 further comprising a second fabric on a side of the substrate opposite the first fabric, the second fabric having a width less than the width of the substrate such that a portion of the substrate is exposed on both sides of the second fabric.

3. The article of claim 1, wherein the plastic polymeric is a thermoplastic polymer.

4. The article of claim 3, wherein the thermoplastic polymer is ethylene methyl acrylate, ethylene-vinyl acetate, polyethylene, polypropylene, or poly(styrene-butadiene-styrene) ethylene methyl acrylate, polyethylene, polypropylene, acrylonitrile butadiene styrene, cellulose acetate, ethylene-vinyl acetate, polyacrylate, polyacrylonitrile, polyamide, polybutadiene, polybutylene, polybutylene terephthalate, polycaprolactone, polyethylene terephthalate, polycarbonate, polyester, polystyrene, polyurea, polyvinyl acetate, polyvinyl chloride, polyvinylidene chloride, styrene-acrylonitrile, ethyl butyl acrylate or mixtures thereof.

5. The article of claim 1, wherein the first fabric is a woven fabric or a nonwoven fabric.

6. The article of claim 1 further comprising
a first water vapor impermeable tape comprising:
a first water vapor impermeable backing;
an adhesive disposed on one surface of the first backing;
a first release sheet covering and releasably attached to one portion of the adhesive on the first backing; and
the other portion of the adhesive on the first backing attached to the exposed portion of the substrate adjacent the first fabric.

7. The article of claim 6 further comprising:
a second water vapor impermeable tape comprising:
a second water vapor impermeable backing;
an adhesive disposed on one surface of the second backing;
a second release sheet covering and releasably attached to one portion of the adhesive on the second backing; and
the other portion of the adhesive on the second backing attached to the exposed portion of the substrate adjacent the first fabric and opposite the first water vapor impermeable tape.

8. A method comprising:
applying to a floor a first elongate sheet of a water vapor impermeable membrane comprising:
a first water vapor impermeable substrate, the first substrate comprising a sheet of polymeric material, the first substrate having a width;
a first fabric on one side of the first substrate, the first fabric having a width less than the width of the first substrate such that a portion of the first substrate is exposed on both sides of the first fabric, said exposed portions of the first substrate forming opposed side edges of the first elongate sheet of a water vapor impermeable membrane; and
a first water vapor impermeable tape comprising:
a first water vapor impermeable backing;
an adhesive disposed on one surface of the first backing;
a first release sheet covering and releasably attached to one portion of the adhesive on the first backing; and
the other portion of the adhesive on the first backing attached to the exposed portion of the first substrate adjacent one of the edges of the first elongate sheet of a water vapor impermeable membrane;
applying to a floor a second elongate sheet of a water vapor impermeable membrane comprising:
a second water vapor impermeable substrate, the second substrate comprising a sheet of plastic material, the second substrate having a width;
a first fabric on one side of the second substrate, the first fabric having a width less than the width of the second substrate such that a portion of the second substrate is exposed on both sides of the first fabric, said exposed portions of the second substrate forming opposed side edges of the second elongate sheet of a water vapor impermeable membrane;
aligning the edges of the first and second elongate sheets of a water vapor impermeable membrane in abutting relationship;
removing the first release sheet; and
placing the exposed edge portion of the second substrate on the portion of the exposed adhesive of the first water vapor impermeable tape thereby adhering the second elongate sheet of water vapor impermeable membrane thereto.

9. A method comprising:
applying to a floor a first elongate sheet of a water vapor impermeable membrane;
applying to the floor a second elongate sheet of a water vapor impermeable membrane;
aligning adjacent edges of the first and second elongate sheets of a water vapor impermeable membrane in abutting relationship; and
adhering the abutting edge of the second elongate sheet of a water vapor impermeable membrane to a portion of a water vapor impermeable adhesive tape, a portion of which is adhered to the abutting edge of the first elongate sheet of a water vapor impermeable membrane.

10. The method of claim 9 further comprising removing a release sheet from the portion of the water vapor impermeable adhesive tape before the abutting edge of the second elongate sheet of a water vapor impermeable membrane is adhered thereto.

11. The method of claim 9, wherein the water vapor impermeable adhesive tape is disposed between the first and second elongate sheets of a water vapor impermeable membrane and the floor.

12. A method comprising:
applying to a floor a first sheet of a water vapor impermeable membrane;
applying to the floor a second sheet of a water vapor impermeable membrane;
aligning adjacent edges of the first and second sheets of water vapor impermeable membrane in abutting relationship and such that the edge of the second sheet of water vapor impermeable membrane overlays a release sheet on an adhesive portion of a water vapor impermeable adhesive tape adhered to the abutting edge of the first sheet of water vapor impermeable membrane;
removing the release sheet from the adhesive portion of the water vapor impermeable adhesive tape; and
adhering the abutting edge of the second sheet of a water vapor impermeable membrane to the adhesive portion of the water vapor impermeable adhesive tape.

13. The method of claim 12, wherein the first and second sheets of water vapor impermeable membrane each comprise a layer of extruded polymeric material sandwiched between opposed layers of nonwoven fabric.

14. An article comprising:
a layer of a water vapor impermeable polymeric material;
a layer of adhesive on one side of the layer of polymeric material; and
a release sheet removably adhered to the adhesive layer, the release sheet being cut or perforated so that a portion of the release sheet can be removed from the adhesive layer while another portion of the release sheet remains.

15. A method comprising:
applying to a floor a water vapor impermeable adhesive tape comprising:
a layer of a water vapor impermeable plastic;
a layer of adhesive on one side of the layer of plastic; and
a release sheet removably adhered to the adhesive layer, the release sheet being at least partially cut so that a portion of the release sheet can be removed from a portion of the adhesive layer while another portion of the release sheet remains;
applying to the floor a first sheet of a water vapor impermeable membrane;
removing a portion of the release sheet to expose a portion of the adhesive layer;
adhering to the exposed portion of the adhesive layer an edge of the first sheet of water vapor impermeable membrane;
applying to the floor a second sheet of a water vapor impermeable membrane;
aligning an adjacent edge of the second sheet of water vapor impermeable membrane in butting relationship with the edge of the first sheet of water vapor impermeable membrane and overlaying the remaining portion of the release sheet;
removing the remaining portion of release sheet to expose the remaining portion of the adhesive layer; and
adhering the abutting edge of the second sheet of a water vapor impermeable membrane to the remaining portion of the adhesive layer.
